(19) United States
(12) Patent Application Publication
(10) Pub. No.: US 2023/0127762 A1
(43) Pub. Date: Apr. 27, 2023

(54) Remote Control for Self-Propelled Working Device

(71) Applicant: Wacker Neuson Produktion GmbH & Co. KG, Reichertshofen (DE)

(72) Inventors: Christian Lange, Ingolstadt (DE); Felix Steghofer, München (DE); Ulrich Ludmann, München (DE); Stephan Stegmeir, Schrobenhausen (DE); Helmut Bauer, Dorfen (DE)

(21) Appl. No.: 17/969,812

(22) Filed: Oct. 20, 2022

(30) Foreign Application Priority Data
Oct. 21, 2021 (DE) 10 2021 127 370

(51) Int. Cl. E02F 9/20; G05D 1/00

(52) U.S. Cl. CPC E02F 9/205; G05D 1/0016; G05D 2201/0202

(57) ABSTRACT

A remote control module for a self-propelled working device has a terminal data interface for interchanging data with a mobile terminal using a terminal data protocol specific to the terminal type, and a working device data interface for interchanging data with the working device using a working device data protocol specific to the working device type. A processing unit is adapted, when the mobile terminal is coupled to the self-propelled working device, to determine the identity and the type of the terminal and the identity and the type of the working device via the respective data interface or to retrieve them from a data memory, to reciprocally translate the respective data protocols when interchanging data between the terminal and the working device, and to transmit machine control data (MCD) from the terminal to the working device and to transmit machine status data (MSD) from the working device to the terminal.

### BACKGROUND OF THE INVENTION

### 1. Field of the Invention

The invention relates to a remote control module and to a remote control system for a self-propelled working device, to a self-propelled working device, and to a method for remotely controlling the latter.

### 2. Description of the Related Art

There are a multiplicity of remote controls for self-propelled working devices, for example vibratory plates, trench rollers or excavators, which are controlled using a remote control apparatus assigned thereto. In this case, the remote controls are configured in such a manner that they remotely control the working device in a similar manner to a remote control for model vehicles via a radio connection or an infrared connection, wherein the remote control is effected by manually adjusting operating levers or joysticks. A type of remote control is always assigned or dedicated to a particular type of machine in this case. Since the remote control apparatus is always tied to the respective machine type or the type of working device, it is not compatible with other machine types or working device types. Each individual machine or each individual working device therefore usually has a single remote control which always remains on precisely that machine or working device.

Since the known remote control apparatuses generally do not have a processor unit, but rather are largely based on analog circuits, it is not possible to change the operating concept or a user interface without adapting the remote control interface (number and position of the operating levers or joysticks) and without adapting the hardware of the remote control apparatus. Therefore, only one operating concept for each remote control apparatus, and no adaptation of the operating concept, is possible, since the hardware of the known remote control apparatuses can be changed only with a large amount of effort and associated costs.

EP 702 317 discloses a remote control of a self-propelled forklift truck via a mobile terminal such as a smartphone or tablet PC, in which an emergency stop operation is implemented if particular boundary conditions of the forklift truck are exceeded. However, the operator interface for remotely controlling the working device is permanently assigned to the machine type, that is to say the remotely controlled forklift truck.

### SUMMARY OF THE INVENTION

The invention is therefore based on the object of specifying a remote control module and a remote control system for a self-propelled working device and a method for remotely controlling the latter, which make it possible for a multiplicity of different working device types to be remotely controlled via of a multiplicity of different terminal types in a universally usable manner.

This object is achieved, according to the invention, by the subject matter of the independent claims. Advantageous configurations and developments of the invention are defined in the subclaims.

The invention provides a remote control module for a self-propelled working device, which has a terminal data interface for interchanging data with a mobile terminal using a terminal data protocol specific to the terminal type, and a working device data interface for interchanging data with the working device using a working device data protocol specific to the working device type. The remote control module also has a processing unit which is adapted, when the mobile terminal is coupled to the self-propelled working device, to determine the identity and the type of the terminal and the identity and the type of the working device via the respective data interface or to retrieve them from a data memory. The processing unit is also adapted to reciprocally translate the respective data protocols when interchanging data between the terminal and the working device. Finally, the processing unit is adapted to transmit machine control data from the terminal to the working device and to transmit machine status data from the working device to the terminal.

A remote control module for a self-propelled working device is therefore provided, which remote control module makes it possible for the self-propelled working device to be remotely controlled via the mobile terminal irrespective of the working device type or terminal type. For this purpose, when coupled to the mobile terminal and to the self-propelled working device, the remote control module according to the invention identifies the corresponding type of the terminal and of the working device and switches between the different data protocols during remote control and when transmitting machine status data. The remote control module also transmits the working device type to the mobile terminal such that a user interface or a GUI (Graphical User Interface) can be accordingly adapted to the working device type. Different operating concepts are displayed for different working device types, for example, whereas other operating concepts are not displayed or are hidden. The remote control module according to the invention therefore provides universal remote control which can be operated easily, for example using a smartphone or tablet PC, and also makes it possible for different working devices to be remotely controlled via a single mobile terminal.

In order to be able to adapt the user interfaces according to the different operating concepts of the different working device types, it is advantageous if the processing unit transmits characteristic data to the mobile terminal on the basis of the identity and/or the type of the terminal and/or of the working device, on the basis of which data different predetermined user interfaces are provided on the mobile terminal.

Since there is no analog remote control via manual operating levers or joysticks in the remote control module according to the invention, but rather different control concepts are effected via gesture control on a touchscreen, it is advantageous if the processing unit is adapted to process machine control data received from the terminal and to transmit machine control data adapted to the working device to the working device.

For simplified remote control of the working device, wherein the user does not have to place himself in the coordinate system of the moving working device, but rather can command a direction of travel, which corresponds to the gesture direction of the finger on the user interface, on the user interface via finger control irrespective of the orientation of the working device and of the mobile terminal, it is expedient if the processing unit is also adapted to offset pose data of the mobile terminal and of the self-propelled working device against one another in such a manner that the current orientation of the real working device correlates with the current orientation of the virtual working device on a user interface of the mobile terminal.

In this case, it is advantageous if the processing unit modifies machine control data received from the mobile terminal on the basis of the pose data of the mobile terminal and of the self-propelled working device that have been offset against one another in such a manner that direction-compatible control of the working device via the terminal is enabled.

For simple operation of the self-propelled working device via the mobile terminal by simply moving the mobile terminal, it is advantageous if the processing unit processes machine control data from the terminal in such a manner that a movement of the terminal in space is converted according to inclination and tilt control into travel command data for the working device.

For intuitive, playful and direction-compatible control of the working device via the terminal, it is expedient if the processing unit processes machine control data from the terminal in such a manner that a movement of a finger in a user interface on a touchscreen of the terminal is converted according to single-finger control into travel command data for the working device.

In order to be able to also use further pose information such as the distance between the operator and the working device, in addition to the orientation of the terminal and of the working device, in order to implement, for example, a maximum distance or a minimum distance with a corresponding emergency stop, it is advantageous if the processing unit is also adapted to offset pose data of the mobile terminal and of the self-propelled working device against one another in such a manner that machine control data from the terminal are modified on the basis of the relative pose, in particular the distance and/or the relative orientation between the terminal and the working device.

The invention also provides a self-propelled working device having a working machine unit for carrying out a work activity, an internal machine control unit for controlling the working machine unit via machine control data and for determining machine status data of the working machine unit, and a remote control module according to the invention.

The invention also provides a remote control system for a self-propelled working device, having a mobile terminal with a user interface for displaying machine status data and for inputting machine control data, a self-propelled working device with an internal machine control unit for receiving machine control data and for transmitting machine status data, and a remote control module according to the invention.

In order to enable direction-compatible control of the working device via the terminal, it is a major advantage if the remote control system has a pose detection unit for determining the spatial pose of the self-propelled working device, wherein the pose detection unit is adapted to transmit pose data of the self-propelled working device and/or of the mobile terminal to the remote control module.

In the case of remote control and pose detection via a GPS system installed in the working device, it is expedient if the remote control module and the pose detection unit are installed in the self-propelled working device, wherein the terminal data interface is wireless and the working device data interface enables wired communication with the machine control unit of the working device.

In the case of remote control and pose determination of the working device via a UWB (Ultra Wide Band) RTLS (Real Time Locating System) system, it is advantageous if the remote control module and the pose detection unit are provided in a positioning module separate from the self-propelled working device, wherein the terminal data interface is wireless and the working device data interface enables wireless communication with the machine control unit of the working device.

The invention also provides a method for remotely controlling a self-propelled working device via a mobile terminal, having the following steps. In the method according to the invention, a terminal data interface for interchanging data with the mobile terminal using a terminal data protocol specific to the terminal type is first of all provided. A working device data interface for interchanging data with the working device using a working device data protocol specific to the working device type is also provided. When the mobile terminal is coupled to the self-propelled working device, the identity and the type of the remotely controlling terminal and the identity and the type of the remotely controlled working device are determined via the respective data interface or are retrieved from a data memory. The respective data protocols are then reciprocally translated when interchanging data between the terminal and the working device, wherein machine control data are transmitted from the terminal to the working device and machine status data are transmitted from the working device to the terminal.

The method according to the invention may advantageously also have the step of offsetting the pose data of the mobile terminal and of the self-propelled working device against one another in such a manner that the current orientation of the real working device correlates with the current orientation of the virtual working device on a user interface of the mobile terminal.

In this case, it is advantageous if machine control data received from the mobile terminal are modified on the basis of the pose data of the mobile terminal and of the self-propelled working device that have been offset against one another in such a manner that direction-compatible control of the working device via the terminal is enabled.

In this case, it is advantageous if machine control data from the terminal are processed in such a manner that a movement of the terminal in space is converted according to inclination and tilt control into travel command data for the working device.

It is also expedient if machine control data from the terminal are processed in such a manner that a movement of a finger in a user interface on a touchscreen of the terminal is converted according to single-finger control into travel command data for the working device.

It is also advantageous if pose data of the mobile terminal and of the self-propelled working device are offset against one another in such a manner that machine control data from the terminal are modified on the basis of the relative pose, in particular the distance and/or the relative orientation between the terminal and the working device.

The above object is also achieved via a computer program comprising instructions which, when executed by a mobile terminal and/or a remote control module, cause it to carry out the method described above.

The above object is also achieved via a computer-readable medium comprising instructions which, when executed by a mobile terminal and/or a remote control module, cause it to carry out the above method.

Finally, the invention provides a data processing apparatus comprising means for carrying out the method according to the invention.

### BRIEF DESCRIPTION OF THE DRAWINGS

An exemplary embodiment of the invention is explained in more detail below, for example, on the basis of the drawing, in which:

FIG. 1 shows a block diagram of a remote control system according to one exemplary embodiment of the invention,

FIG. 2 shows a flowchart of a method for remotely controlling a self-propelled working device according to one exemplary embodiment of the invention,

FIG. 3 shows a highly simplified schematic view of a remote control system having GPS pose detection of the working device according to one exemplary embodiment of the invention,

FIG. 4 shows a highly simplified schematic view of a remote control system having UWB RTLS pose detection of the working device according to one exemplary embodiment of the invention,

FIGS. 5A to 5C show user interfaces on a mobile terminal with different operating concepts according to different exemplary embodiments of the invention, and

FIG. 6 shows a schematic view for illustrating universal remote control via the remote control system according to the invention.

### DETAILED DESCRIPTION

In the various figures of the drawing, components which correspond to one another are provided with the same reference signs.

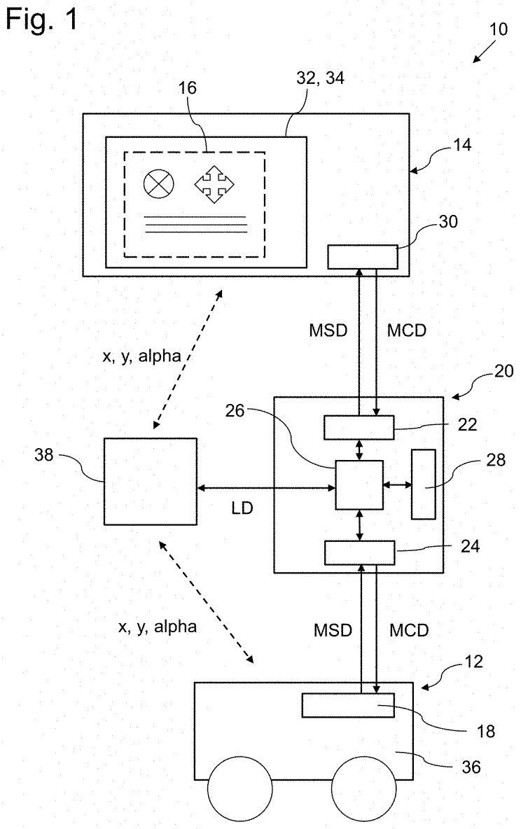

FIG. 1 shows a schematic block view of a remote control system 10 for a self-propelled working device 12 according to the invention. In this case, the remote control system 10 has a mobile terminal 14 with a user interface 16 for displaying machine status data MSD and for inputting machine control data MCD. The self-propelled working device 12 has an internal machine control unit 18 for receiving machine control data MCD and for transmitting machine status data MSD.

The remote control system 10 according to the invention also comprises a remote control module 20 which makes it possible to remotely control the working device 12 via the mobile terminal 14 irrespective of the terminal type and/or working device type. For this purpose, the remote control module 20 has a terminal data interface 22 for interchanging data with the mobile terminal 14 using a terminal data protocol specific to the terminal type, and a working device data interface 24 for interchanging data with the working device 12 using a working device data protocol specific to the working device type. The remote control module 20 according to the invention also has a processing unit 26 which is adapted, when the mobile terminal 14 is coupled to the self-propelled working device 12, to determine the identity and the type of the terminal 14 and the identity and the type of the working device 12 via the respective data interface 22, 24 or to retrieve them from a data memory 28. The processing unit 26 is also adapted to reciprocally translate the respective data protocols when interchanging data between the terminal 14 and the working device 12 and to transmit machine control data MCD from the terminal 14 to the working device 12 and to transmit machine status data MSD from the working device 12 to the terminal.

The mobile terminal 14 communicates with the terminal data interface 22 via a remote control module data interface 30 in order to interchange data, for example the machine control data MCD and the machine status data MSD, with the terminal data interface 22 of the remote control module 20. The mobile terminal 14 may be in the form of a smartphone, a tablet PC or a laptop, but the intention is also to include any device which is adapted to provide wireless or wired data communication with the remote control module 20 and to provide a user interface 16, via which a user can transmit at least machine control data MCD to the remote control module 20 and can preferably receive machine status data MSD and can display said data on the user interface or can process said data accordingly.

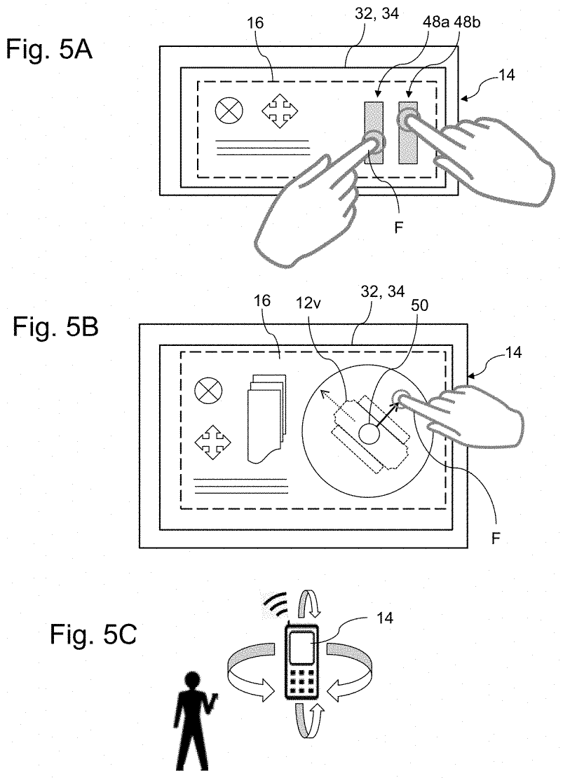

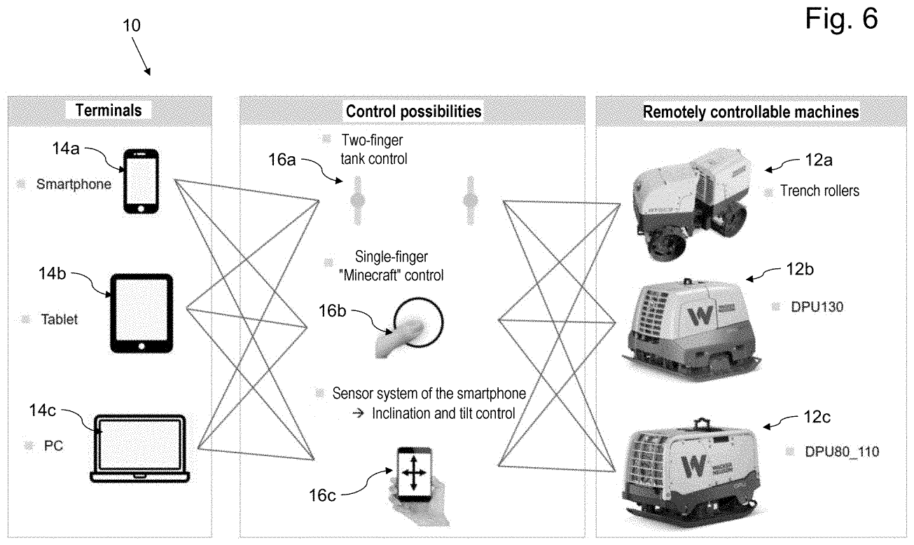

If the mobile terminal 14 is in the form of a smartphone, a tablet PC or a laptop, the user interface 16 is produced via a corresponding computer program or via an application (app) on the mobile terminal 14, wherein the mobile terminal 14 has a screen 32 and an input apparatus 34 for this purpose. In the case of a configuration as a touchscreen in a smartphone or a tablet PC, the input apparatus 34 may coincide with the screen 32, as a result of which a simple and intuitive input of commands by a user via finger gestures on the touch-sensitive touchscreen 32, 34 is enabled. The different operating concepts for different working devices 12 will be described in even more detail below in the description of FIGS. 5A to 5C and FIG. 6.

The machine control data MCD are transmitted and the machine status data MSD are optionally received by the remote control data interface 30 of the mobile terminal 14 using a terminal data protocol specific to the terminal type. In the case of wireless communication between the mobile terminal 14 and the remote control module 20, a WLAN protocol, a Bluetooth protocol or a conventional mobile radio protocol such as 3G, 4G or 5G can be used as the terminal data protocol. In the case of future mobile radio standards after the 5G standard in particular, low latency times enable quasi-real-time remote control of working devices 12 via a mobile terminal 14 via a mobile radio connection which runs via a known mobile radio network. However, it is also possible for the communication between the mobile terminal 14 and the remote control module 20 to take place via an infrared interface or a manufacturer-specific radio interface. It is conceivable, for example, for the remote control data interface 30 to be in the form of a separate module which, on the one hand, communicates with the mobile terminal 14 via a USB interface or a Bluetooth interface and, on the other hand, communicates with the terminal data interface 22 of the remote control module 20 using a manufacturer-specific data protocol and via a manufacturer-specific data connection such as a radio connection, an infrared connection or a wired connection.

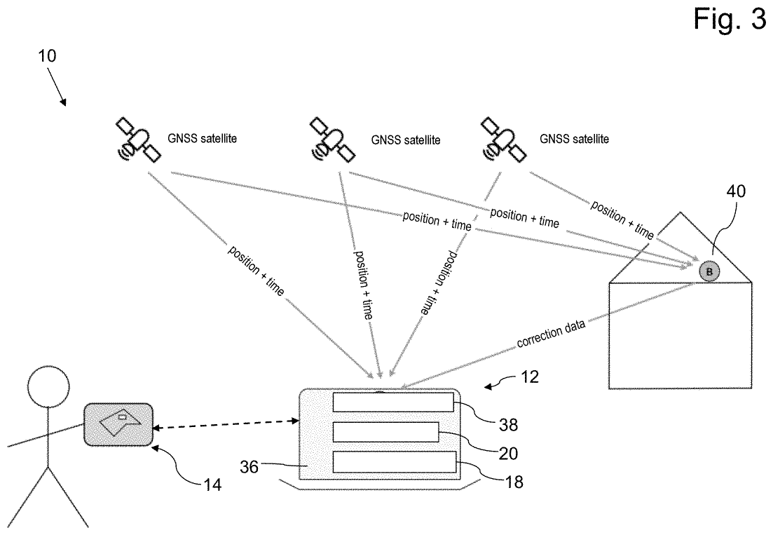

The self-propelled working device 12 has a working machine unit 36 for carrying out a work activity and the internal machine control unit 18 for controlling the working machine unit 36 via the machine control data MCD and for determining machine status data MSD of the working machine unit 36. The remote control module 20 may be permanently installed in the self-propelled working device 12, as will be discussed in even more detail with reference to FIG. 3. The self-propelled working device 12 is preferably in the form of a construction machine, for example a vibratory plate, a trench roller or an excavator, but the use of the invention for remotely controlled vibratory plates and/or trench rollers is preferred. However, the invention is not intended to be restricted thereto, but rather the intention is to include all self-propelled working devices which carry out work or construction activity of any kind or transport construction or work materials and can be remotely controlled.

The remote control and/or the interchange of data between the working device data interface 24 and the internal machine control unit 18 is/are carried out using a working device data protocol specific to the working device type. For example, in the case of working devices 12 which already enable remote control via a known remote control apparatus, the working device data protocol may be matched to the already existing remote control protocol in order to facilitate a simple retrofitting capability of a working device 12, which can already be remotely controlled, via the remote control module 20 according to the invention. If the remote control module 20 is permanently installed in the self-propelled working device 12, the radio or infrared connection can be replaced in this case with a wired data connection, but the transmission or remote control protocol remains the same. The remote control protocol SC2+ for the DPU80 vibratory plate, the remote control protocol SC2 (DPU) for the DPU130 vibratory plate or the remote control protocol SC2 (RT) for the RT trench roller from the applicant are intended to be mentioned, for example, as an example of existing working device data protocols.

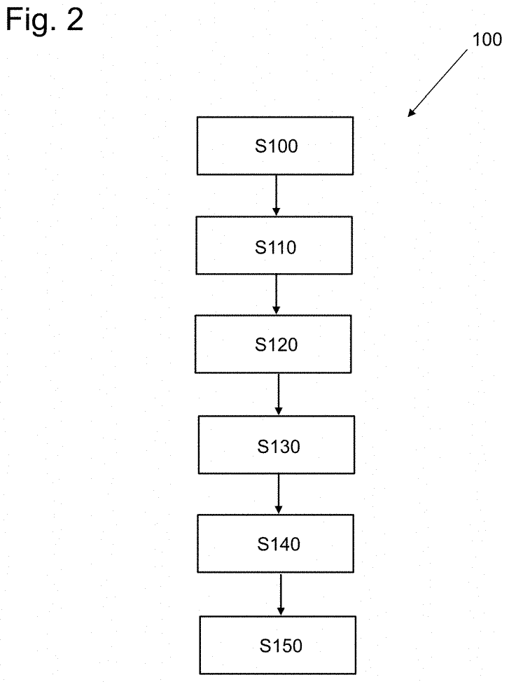

The remote control module 20 therefore enables universally usable remote control by converting the data protocols from the mobile terminal 14 to the self-propelled working device 12 and from the self-propelled working device 12 to the mobile terminal 14, wherein the remote control module 20 has the processing unit 26, which may be in the form of a central processor unit, in order to carry out the following method 100 according to the invention for remotely controlling the self-propelled working device 12 via the mobile terminal 14, as shown in FIG. 2, by executing a computer program or an application.

The terminal data interface 22 for interchanging data with the mobile terminal 14 using a terminal data protocol specific to the terminal and a working device data interface 24 for interchanging data with the working device 12 using a working device data protocol specific to the working device type are provided in steps S100 and S110. In step S120, the mobile terminal 14 is then coupled to the self-propelled working device 12 via the remote control module 20. In a step S130, the processing unit 26 of the remote control module 20 then determines the identity and the type of the remotely controlling terminal 14 and the identity and the type of the remotely controlled working device 12 via the respective data interface 22, 24 or retrieves said data from the data memory 28. If the remote control module 20 is permanently installed in the working device 12 for example, only the respective identity and the type of the terminal 14 can be determined on account of the identity and type of the working device 12 remaining the same. The identity and the type of the terminal 14 are determined via communication between the remote control module 20 and the application running on the terminal 14 or the computer program which generates the user interface 16 for an operator. In order to prevent the working device 12, which in the form of a trench roller or a vibratory plate has an enormous risk potential, from being remotely controlled by unauthorized users, step S130 of determining the identity and the type of the terminal 14 may also have an authentication operation in which the authorization and identity of the remotely controlling user, who is assigned a specific terminal, are checked. After the identity and the type of the terminal 14 and the identity and the type of the working device 12 have been determined in step S130, the processing unit 26 of the remote control module 20 then reciprocally translates the respective data protocols when interchanging data between the terminal 14 and the working device 12 and transmits the machine control data MCD from the terminal 14 to the working device 12 and transmits machine status data MSD from the working device 12 to the terminal 14 in a step S150.

As already mentioned at the outset, this method according to the invention may be carried out by a computer program or an application that comprises instructions which, when the program is executed by the processing unit 26 or possibly also partially by the mobile terminal 14, cause it to carry out the method having steps S100 to S150. The remote control via the mobile terminal 14 is therefore in the form of software which can run on different mobile terminals 14, for example as an app on a smartphone. In this case, the remote control module 20 communicates with the remote control software of the mobile terminal 14 and can process the control signals MCD from the control software on the mobile terminal 14 in accordance with the respective machine type of the working device 12. For this purpose, the machine or the working device 12 and the machine type or working device type and the remote control software on the mobile terminal 14 are uniquely identified in order to adjust the software to the working device 12 to be controlled and also to at least occasionally uniquely assign or couple remote control software on the mobile terminal 14 and the working device 12.

In particular, it is advantageous if the communication between the mobile terminal 14 and the working device 12 via the remote control module 20 is possible in both directions or is bidirectional, that is to say, in addition to receiving machine control data MCD, it is also possible to transmit machine status data MSD from the working device 12 to the mobile terminal 14. Therefore, there is no need for any permanent unique assignment between the control software on the mobile terminal 14 and the working device 12. If the work with a working device 12a has been completed, the remote control software on the mobile terminal 14 can then be coupled to a working device 12b, as shown in FIG. 6, for example. Furthermore, the operating concept can also be changed, as shown in FIGS. 5A to 5C. Since the control by the mobile terminal 14 is formed via software anyway, an operator can choose from different control systems, for example tank control, minecraft control or control via sensors in the mobile terminal 14.

The remote control system 10 may also comprise a pose detection unit 38 for determining the spatial pose of the self-propelled working device 12 and/or of the mobile terminal 14, wherein the pose detection unit 38 is adapted to transmit pose data of the self-propelled working device 12 to the remote control module 20.

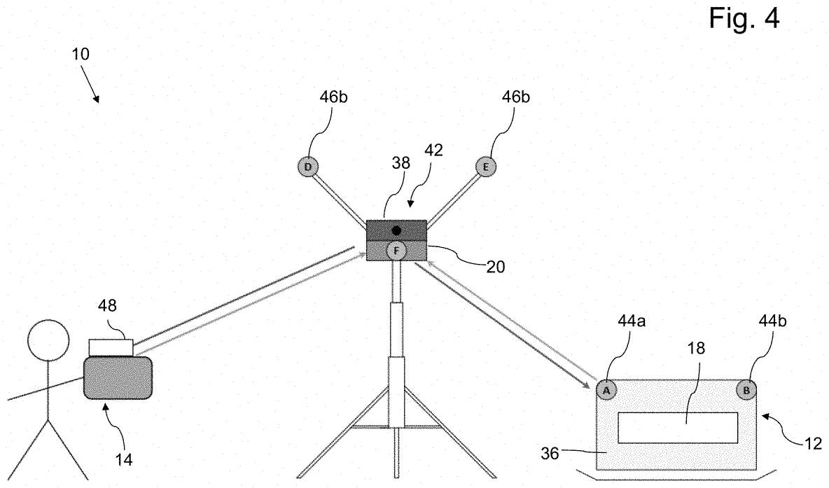

FIGS. 3 and 4 shows specific configurations of a pose detection unit 38 in conjunction with the remote control system 10.

In the exemplary embodiment in FIG. 3, the remote control module 20 and the pose detection unit 38 are permanently installed in the self-propelled working device 12, wherein the terminal data interface 22 to the mobile terminal 14 is wireless and the working device data interface 24 enables internal wired communication with the machine control unit 18 of the working device 12. In the exemplary embodiment shown in FIG. 3, the pose, that is to say the position and orientation on the Earth's surface, are detected via GPS positioning. In this case, the position, that is to say the geographical coordinates, can be determined via GPS, while the azimuthal orientation alpha of the working device 12 is determined via a compass or a north-seeking device. In addition, the position data determined by the satellites can be corrected via a connection to a GPS receiver 40 mounted on a stationary object such as a house. The pose detection unit 38 can therefore transmit very accurate pose data LD to the remote control module 20, wherein the processing unit 26 of the remote control module 20 accordingly processes these pose data in order to accordingly modify machine control data MCD, as will also be explained.

FIG. 4 shows a further exemplary embodiment of a remote control system 10 in which the remote control module 20 and the pose detection unit 38 are provided in a positioning module 42 which is separate from the self-propelled working device 12. In this configuration of the remote control system 10, the terminal data interface 22 of the remote control module 20 is wireless in order to interchange data, in particular machine control data MCD and machine status data MSD, with the mobile terminal 14 using a terminal data protocol specific to the terminal type. Furthermore, the working device data interface 24 of the remote control module 20 is likewise wireless in order to enable wireless communication with the machine control unit 18 of the working device 12. An already known working device data protocol for remotely controlling the working device 12 can be used in this case for the remote control of the working device 12 via the remote control module 20. However, it is preferred for the working device data interface 24 of the remote control module 20 to enable bidirectional data communication with the machine control unit 18 so that machine status data MSD can be transmitted from the working device 12 to the remote control module 20.

In the exemplary embodiment of the remote control system 10 shown in FIG. 4, the pose detection unit 38 is in the form of a UWB RTLS system, wherein it is possible to locate the working device 12 in a very precise and stable manner via UWB (Ultra Wide Band) localization. Positioning via a UWB RTLS system is considerably more accurate than GPS localization or WLAN or Bluetooth/BLE positioning. The pose (position and orientation) of the working device 12 is determined by determining propagation time differences of the electromagnetic radio signal between the positioning module 42 and the object point modules 44a and 44b. In this case, the orientation of the working device 12 with respect to a preferred direction, in particular a north direction on a ground plane, can be determined using differences in the propagation time of the radio signal pulses between the pose detection unit 38 and the first object point module 44a in contrast to the second object point module 44b via triangulation. In order to exactly detect the location (position) of the positioning module 42, two separate measurement point modules 46a and 46b are also provided at a distance from the positioning module 42 in order to determine the position of the positioning module 42 by measuring propagation time differences and via triangulation when the pose of the measurement point modules 46a and 46b is known. According to the exemplary embodiment in accordance with FIG. 4, the pose detection unit 38 of the remote control system 10 can therefore determine the pose data (orientation and position) of the working device 12 in a highly precise manner via triangulation and by measuring propagation time differences of the ultra-wideband radio signal and can transmit said data to the remote control module 20 so that the remote control module 20 can process the pose data of the self-propelled working device 12.

In order to capture the pose data of the mobile terminal 14, a positioning tag or a positioning pendant 48 can be permanently connected to the mobile terminal 14 (for example by configuring the positioning pendant 48 as a smartphone cover or a tablet cover) on the mobile terminal 14. It is also possible for the pose data of the mobile terminal 14 to be captured by the mobile terminal 14 itself (for example using an internal compass or a north-seeking apparatus and via an internal GPS positioning apparatus) and to be transmitted to the remote control module 20 for further processing. However, it is not absolutely necessary to transmit the pose data of the mobile terminal 14 from the mobile terminal 14 to the remote control module 20, since absolute geographical coordinates such as longitude and latitude and an azimuthal orientation alpha with respect to North can be transmitted from the remote control module 20 to the mobile terminal 14 as pose data of the working device 12, wherein the mobile terminal 14 then itself calculates the relative pose (relative orientation and relative position or distance).

As therefore explained with reference to FIGS. 1 to 4, different machines can be controlled according to the invention using only one remote control, which is in the form of a mobile terminal 14, and with various selectable control possibilities. In this case, the control possibilities can be changed at any time. In this case, freely programmable transmitting modules (wireless such as WLAN, Bluetooth or wired) and freely programmable receiving modules are used. In this case, the mobile terminal 14 has application software which produces the user interface 16 in order to transmit movement data to the remote control module 20 which converts the movement data from the mobile terminal 14 into travel command data and sends said data to the internal machine control unit 18 of the working device 12 in order to remotely control the working device 12. In this case, the working device 12 returns machine status data MSD, via the machine control unit 18, to the remote control module 20 which translates these machine status data MSD into a corresponding protocol and transmits it to the mobile terminal 14. Provided for this purpose on the remote control module 20 is generic hardware, on which is formed generic software which undertakes the functions of a receiving unit, a power supply and data processing.

The different control possibilities via different terminals for the remotely controllable machines or working devices 12 are now explained in detail below.

FIGS. 5A to 5C illustrate different user interfaces 16 on a mobile terminal 14 which illustrate different operating concepts or control methods.

FIG. 5A illustrates a user interface 16 on a mobile terminal 14, which user interface virtualizes conventional control for vibratory plates and trench rollers on the mobile terminal 14, which is similarly implemented in known remote control apparatuses by providing two “real” operating levers. In the case of this so-called “tank control”, two levers which are parallel and next to one another and can be manually moved away from the operator or toward the operator are moved in such a manner that, according to the lever excursion, they control a travel speed of a left-hand and a right-hand drive chain or of a left-hand and a right-hand drive wheel. If both levers are therefore moved forward, the machine moves forward since the left-hand chain speed and the right-hand chain speed are the same and cause a forward movement. If the left-hand lever is moved forward and the right-hand lever is moved backward, the machine moves to the right. If the right-hand lever is moved forward and the left-hand lever is moved backward, the machine moves to the left.

In the exemplary embodiment of a user interface 16 of the mobile terminal 14 shown in FIG. 5A, these levers are now depicted virtually on a touchscreen, wherein corresponding “virtual” controllers or operating levers can be adjusted with the fingertips using a sliding movement of the fingertip on the touchscreen. This type of control fundamentally does not require any pose information of the mobile terminal 14 and/or of the working device 12 since, in the case of this control, the remotely controlling user is placed into the travel coordinate system of the working device 12, that is to say looks in the direction of travel virtually mentally sitting on the working device 12. However, in order to correctly convert the travel command data into machine control data so that the working device 12 behaves according to the tank control used, the processing unit 26 is adapted to process remote control data or machine data received from the mobile terminal 14 and to transmit machine control data adapted to the working device 12 to the latter.

However, according to the invention, it is not only possible to use any desired mobile terminal 14 to remotely control the working device 12, but rather the remote control software installed on the mobile terminal 14 can provide a remotely controlling user with different operating concepts for selection on the user interface 16 depending on the machine type of the working device 12. The processing unit 26 of the remote control module 20 can therefore transmit characteristic data to the mobile terminal 14 on the basis of the identity and/or the type of the mobile terminal 14 and/or of the self-propelled working device 12, on the basis of which data different predetermined user interfaces 16 are provided on the mobile terminal 14. For example, data which uniquely identify the type of the working device 12 via a type designation or via a code number can be used here as characteristic data, as a result of which the remote control software installed on the mobile terminal 14 can read possible operating concepts, which are assigned to a corresponding working device type in the characteristic data, from a corresponding database.

FIG. 5B shows such a further operating concept according to another exemplary embodiment of a user interface 16 on a mobile terminal 14. In the case of this user interface 16, the working device 12 is remotely controlled via the mobile terminal 14 on the basis of so-called “minecraft control”. In the case of such a type of control, a starting point 50, on which a finger F of a user is placed during remote control of the working device 12, is displayed on a touchscreen 32, 34. If the fingertip is moved in a direction away from the starting point 50 on the touchscreen 32, 34, the machine also moves in the respective direction. The distance between the fingertip on the touchscreen 32, 34 and the starting point 50 in this case defines the travel speed of the working device 12. The control is therefore similar to that in the case of a virtual joystick which is imaged or projected onto a virtual touchscreen surface in a plan view from above. The direction of the excursion on the touchscreen therefore specifies the direction of travel of the working device 12, while the severity of the excursion (that is to say the distance from the starting point 50) specifies the speed of the working device 12.

This so-called minecraft control can be used in this case without further processing of the pose data of the mobile terminal 14 and/or of the working device 12, wherein the user interface 16 should always be kept in the same orientation with respect to the user for this purpose and the working device 12 is also controlled according to the moving coordinate system of the working device 12. In this case, however, a user must move in the direction of travel of the working device 12 mentally sitting on the working device 12. According to the invention, direction-compatible control of the working device 12 is therefore preferred, as described below.

With this type of remote control, the pose data of the mobile terminal 14 and of the self-propelled working device 12 are offset against one another in such a manner that the current orientation of the real working device 12 correlates with or matches the current orientation of a virtual working device 12v on the user interface 16 of the mobile terminal 14. Although the virtual working device 12v is depicted with its direction of travel arrow in FIG. 5B for the purpose of illustrating the control principle, this need not necessarily be the case for an actual configuration of a user interface 16 with minecraft control. It is only important that it is possible to determine a relative orientation between the terminal 14 and the working device 12, on the basis of which the orientation of the virtual working device 12v within the user interface 16 of the mobile terminal 14 can then be calculated and possibly displayed in the user interface 16.

Since the remote control for self-propelled working devices 12 is aimed at ground vehicles, an orientation of the mobile terminal 14 and of the working device 12 is intended to be understood as meaning an orientation within the ground plane of the Earth's surface, for example an azimuthal orientation, in which the azimuth indicates the relative orientation angle with respect to North. If the mobile terminal 14 is not kept parallel to the ground surface or the working device 12 is on a slope, the orientation of the mobile terminal 14 and/or of the working device 12 is intended to be understood as meaning the corresponding vertical projection onto an imaginary planar surface or water surface on the Earth's surface. The processing unit 26 therefore modifies machine control data MCD received from the mobile terminal 14 on the basis of the pose data of the mobile terminal 14 and of the self-propelled working device 12 which have been offset against one another in such a manner that direction-compatible control of the working device 12 via the terminal 14 is enabled. In this case, only the orientation of the remotely controlling mobile terminal 14 and of the working device 12 relative to one another must be determined, for example via a compass apparatus, via the described UWB (Ultra Wide Band) positioning or via RTK (Real Time Kinematic) positioning.

In this case, the direction-compatible control additionally depends on the type of the working device 12. For example, in the case of technical positive coupling of driving and rotation of the working device 12, a mixed form of direction-compatible control and cockpit control (in which the user looks in the direction of travel mentally sitting on the machine) can be implemented.

In a first case for example, if the operator does not release the operating element during the entire control program, the working device 12, if its direction of travel points in the viewing direction of the operator, may initially move away from the operator if the operator sets a forward movement on the remote control. If the operator then uses the working device 12 to move on a 180° bend (the front of the working device 12 points toward the operator) and does not release the controller in the process, the working device 12 moves toward the operator, even though the operator has still set a forward movement. The control therefore takes place within the travel coordinate system of the working device 12 according to cockpit control.

In a second case, however, the operator may release the operating element after completing the 180° bend. As a result of the new control operation, the system then returns to direction-compatible control, as a result of which the working device 12 does not move toward the user, but rather away from the user, in the case of forward control or movement on the touchscreen 32, 34.

In the case of other working devices 12, for example a 4Q vibratory plate, complete direction-compatible control is possible since this device can carry out all movement directions and rotational directions separately from one another. Here, a corresponding movement vector is specified using the remote control, as described above with reference to the minecraft control in FIG. 5B, wherein the machine follows this movement vector exactly irrespective of its orientation relative to the operator. The processing unit 26 therefore processes the machine control data MCD from the mobile terminal in such a manner that a movement of a finger F in a user interface 16 on a touchscreen 32, 34 of the terminal 14 is converted according to single-finger control or minecraft control into travel command data for the working device 12.

FIG. 5C shows a further control possibility for the working device 12, in which no operation via a touchscreen 32, 34 needs to take place. This control is preferred, in particular, for use during a construction activity since a mobile terminal 14, for example a smartphone or a tablet PC, can be completely enclosed and protected from dirt and water without having to access the touchscreen 32, 34. During this control via inclination and tilt control, the machine control data MCD from the mobile terminal 14 are processed in such a manner that a movement of the terminal 14 in space is converted according to inclination and tilt control into the travel command data for the working device 12. However, it is necessary for this purpose for the mobile terminal 14 to have a corresponding sensor system such as an inertial measurement unit, IMU for short. This integrated pose sensor system can then be accessed by the remote control software on the mobile terminal 14 in order to determine corresponding control commands. The control possibility shown in FIG. 5C is very intuitive control of the working device 12, which, as described above, can be conducted either in a partially or in a fully direction-compatible manner, wherein forward inclination of the mobile terminal 14 produces a forward movement of the working device 12, backward inclination of the mobile terminal 14 produces a backward movement, tilting of the mobile terminal 14 to the left produces a movement of the working device 12 to the left, and tilting of the mobile terminal 14 to the right produces a movement of the working device 12 to the right, wherein all mixed forms of the inclination and tilting movement of the mobile terminal 14 are converted into corresponding combined travel movements.

However, the processing of the pose data is not only intended to be restricted to the relative orientation of the working device 12 and of the mobile terminal 14, but rather there are yet further applications in which the remote control can be influenced on the basis of the relative pose data. The processing unit 26 may also be adapted to offset the pose data of the mobile terminal 14 and of the self-propelled working device 12 against one another in such a manner that machine control data MCD from the terminal 14 are modified on the basis of the relative pose, in particular the distance and/or the relative orientation between the terminal 14 and the working device 12. For example, a modification of the machine control data MCD from the terminal 14 may involve an emergency stop being carried out in the case of a minimum safety distance between the operator or the mobile terminal 14 and the working device 12. However, it is also conceivable for stopping of the machine to likewise be enforced in the case of a maximum distance between the mobile terminal 14 and the working device 12 in order to prevent an operator from actuating the device at a distance at which the operator can no longer reliably exclude collisions or accidents with objects or persons.

However, it is also conceivable for the absolute pose of the working device 12 and/or of the mobile device 14 to decide on the remote control possibility. For example, a ground region or a so-called geo-fence, which covers a particular ground area of the Earth's surface, can decide whether the working device 12 can be operated. For example, it is possible to stipulate that the mobile terminal 14 is within the stipulated ground region or within the stipulated geo-fence in order to prevent an unauthorized person who is not in the construction site area (in the defined geo-fence or ground region) from remotely controlling machines in an unauthorized manner. It is therefore also possible to prevent authorized workers from inadvertently activating machines upon leaving the construction area (the stipulated ground region). In a similar manner, it is also possible to define a geo-fence or a virtual round area for the working device 12, in which remote control and moving of the working device 12 are permitted. For example, it is possible to prevent a trench roller or a vibratory plate from moving into an area in which a construction shaft is currently being dug.

Furthermore, a modification of the machine control data MCD may also mean that different travel speeds are permitted in stipulated virtual ground regions or geo-fence regions. Finally, the permitted travel speed may also be gradually reduced on the basis of the distance between the mobile terminal 14 and the working device 12 in order to increase the safety of the remotely controlled travel mode of the working device 12. Therefore, it is no longer possible to travel as quickly when there is a large distance between the mobile terminal 14 and the working device 12 as when there is a short distance between the mobile terminal 14 or the user and the working device 12.

In summary, as shown in FIG. 6, various machines or working devices 12a, 12b, 12c can therefore be operated/remotely controlled with various control possibilities using only one mobile application-capable and updateable terminal. A simple updateability of the system and therefore flexible usability are therefore enabled. The prerequisite for this is an application-capable and updateable mobile terminal 14a, 14b, 14c, for example a smartphone, a tablet PC or a laptop or any type of terminal having these properties. The variable and therefore adaptable user interfaces therefore make it possible, as shown in FIG. 6, for different terminals 14a, 14b, 14c to be equipped with different control possibilities or user interfaces 16a, 16b, 16c via the remote control software on the terminal 14 in order to in turn operate different remotely controllable machines or working devices 12a, 12b, 12c of different types.

The control of the software also enables direction compatibility, that is to say the machine and the remote control identify the orientation relative to one another, with the result that a travel command “forward” always triggers a movement away from the operator, whereas “backward” always means toward the operator. In other words, the operator need no longer consider the direction in which the machine is oriented in order to then make possibly mirror-inverted control inputs. The control or software always implements the control signals in the manner in which they should be used from the point of view of the operator. In this case, the solution according to the invention is preferably enabled by the remote control module 20 on the working device 12. It is therefore conceivable to also provide older machines with a remote control module 20 in order to retrofit the remote control of the working device 12.

In the wireless communication system, as described with reference to FIGS. 1 to 6, a machine is therefore controlled with the aid of a sensor system of a mobile “app-capable and updateable” terminal 14a, 14b, 14c (for example smartphone, tablet, laptop or the like), wherein freely selectable operating concepts or user interfaces 16a, 16b, 16c, for example two-finger control (“tank control”), single-finger control (“minecraft control”) or inclination and tilt control (“IMU control”), are enabled. In this case, either completely direction-compatible control or partially direction-compatible control (returning to direction compatibility following release by a user) may be enabled. Different machines can therefore be operated using only one remote control, in which case retrofitting is possible. The remote control module 20 can therefore also be used as an accessory for any desired remotely controllable construction machines. Furthermore, the remote control system 10 according to the invention has the major advantage that machine status data are managed and queried within the same user interface 16.

1. A remote control module for a self-propelled working device, comprising:
a terminal data interface for interchanging data with a mobile terminal using a terminal data protocol specific to a terminal type;
a working device data interface for interchanging data with the working device using a working device data protocol specific to a working device type; and
a processing unit which is adapted
when the mobile terminal is coupled to the self-propelled working device, to determine an identity of the terminal and the type of the terminal and the identity of the working device and the type of the working device via the respective data interface or to retrieve them from a data memory,
to reciprocally translate the respective data protocols when interchanging data between the terminal and the working device, and
to transmit machine control data (MCD) from the terminal to the working device and to transmit machine status data (MSD) from the working device to the terminal.

2. The remote control module as claimed in claim 1, wherein the processing unit transmits characteristic data to the mobile terminal on the basis of at least one of the identity and/or the type of the terminal and the and identity and/or type of the working device, on the basis of which data different predetermined user interfaces are provided on the mobile terminal.

3. The remote control module as claimed in claim 1, wherein the processing unit is adapted to process machine control data (MCD) received from the terminal and to transmit machine control data (MCD) that is adapted to the working device to the working device.

4. The remote control module as claimed in claim 1, wherein the processing unit is adapted to offset pose data of the mobile terminal and of the self-propelled working device against one another in such a manner that a current orientation of the real working device correlates with a current orientation of the virtual working device on a user interface of the mobile terminal.

5. The remote control module as claimed in claim 4, wherein the processing unit is adapted to modify machine control data (MCD) received from the mobile terminal on the basis of the pose data of the mobile terminal and of the self-propelled working device that have been offset against one another in such a manner that direction-compatible control of the working device via of the terminal is enabled.

6. The remote control module as claimed in claim 5, wherein the processing unit is adapted to process machine control data (MCD) from the terminal in such a manner that a movement of the terminal in space is converted according to inclination and tilt control into travel command data for the working device.

7. The remote control module as claimed in claim 5, wherein the processing unit is adapted to process machine control data (MCD) from the terminal in such a manner that a movement of a finger (F) in a user interface on a touchscreen of the terminal is converted according to single-finger control into travel command data for the working device.

8. The remote control module as claimed in claim 1, wherein the processing unit is adapted to offset pose data of the mobile terminal and of the self-propelled working device against one another in such a manner that machine control data (MCD) from the terminal are modified on the basis of the at least one of a distance between the terminal and the working device and a relative orientation between the terminal and the working device.

9. A self-propelled working device, comprising:
a working machine unit for carrying out a work activity;
an internal machine control unit for controlling the working machine unit using control data (MCD) and for determining machine status data (MSD) of the working machine unit; and
a remote control module comprising
a terminal data interface for interchanging data with a mobile terminal using a terminal data protocol specific to a terminal type;
a working device data interface for interchanging data with the working device using a working device data protocol specific to a working device type; and
a processing unit which is adapted
when the mobile terminal is coupled to the self-propelled working device, to determine the identity and the type of the terminal and the identity and the type of the working device via the respective data interface or to retrieve them from a data memory,
to reciprocally translate the respective data protocols when interchanging data between the terminal and the working device, and
to transmit machine control data (MCD) from the terminal to the working device and to transmit machine status data (MSD) from the working device to the terminal.

10. A remote control system for a self-propelled working device, having
a mobile terminal with a user interface for displaying machine status data (MDS) and for inputting machine control data (MCD);
a self-propelled working device with an internal machine control unit for receiving machine control data (MCD) and for transmitting machine status data (MSD); and
a remote control module including:
a terminal data interface for interchanging data with a mobile terminal using a terminal data protocol specific to a terminal type;
a working device data interface for interchanging data with the working device using a working device data protocol specific to a working device type; and
a processing unit which is adapted
when the mobile terminal is coupled to the self-propelled working device, to determine the identity and the type of the terminal and the identity and the type of the working device via the respective data interface or to retrieve them from a data memory,
to reciprocally translate the respective data protocols when interchanging data between the terminal and the working device, and
to transmit machine control data (MCD) from the terminal to the working device and to transmit machine status data (MSD) from the working device to the terminal.

11. The remote control system as claimed in claim 10, further comprising
a pose detection unit for determining a spatial pose (x, y, alpha) of the self-propelled working device, wherein the pose detection unit is adapted to transmit pose data (LD) of at least one of the self-propelled working device and the mobile terminal to the remote control module.

12. A method for remotely controlling a self-propelled working device using a mobile terminal, the method comprising:
providing a terminal data interface for interchanging data with the mobile terminal using a terminal data protocol specific to a terminal type;
providing a working device data interface for interchanging data with the working device using a working device data protocol specific to the working device type;
coupling the mobile terminal to the self-propelled working device;
determining an identity and the type of the terminal and an identity and type of the working device via the respective data interface or retrieving them from a data memory;
reciprocally translating the respective terminal and working device data protocols when interchanging data between the terminal and the working device; and
transmitting machine control data (MCD) from the terminal to the working device and transmitting machine status data (MSD) from the working device to the terminal.

13. A data processing apparatus for remotely controlling a self-propelled working device using a terminal data interface for interchanging data with a mobile terminal using a terminal data protocol specific to a terminal type, the data processing apparatus comprising:
means for providing a working device data interface for interchanging data with the working device using a working device data protocol specific to the working device type;
means for coupling the mobile terminal to the self-propelled working device;
means for determining an identity and the type of the terminal and an identity and type of the working device via the respective data interface or retrieving them from a data memory;
means for reciprocally translating the respective terminal and working device data protocols when interchanging data between the terminal and the working device; and
means for transmitting machine control data (MCD) from the terminal to the working device and transmitting machine status data (MSD) from the working device to the terminal.
